(19) United States
(12) Patent Application Publication
(10) Pub. No.: US 2016/0229201 A1
(43) Pub. Date: Aug. 11, 2016

(54) Recording Apparatus

(71) Applicant: Seiko Epson Corporation, Tokyo (JP)

(72) Inventor: Ryota Takenaka, Matsumoto-Shi (JP)

(21) Appl. No.: 15/017,806

(22) Filed: Feb. 8, 2016

(30) Foreign Application Priority Data
Feb. 10, 2015 (JP) 2015023891

(51) Int. Cl. B41J 11/00

(52) U.S. Cl. CPC B41J 11/0015; B41J 11/007

(57) ABSTRACT

A recording apparatus includes a feeding unit that feeds transfer paper, a recording section that performs recording by applying ink to the transfer paper, and a medium supporting unit that is arranged on a transfer paper feed downstream side of the feeding unit and that supports the transfer paper. The medium supporting unit includes a bent portion that is bent so that a side that comes into contact with the transfer paper is convex and that extends in a direction that crosses the feed direction of the transfer paper, and the bend angle of the bent portion is equal to or more than 3° and equal to or less than 16°.

### BACKGROUND

1. Technical Field

The present invention relates to a recording apparatus including a medium supporting unit that supports a medium.

2. Related Art

To date, there is a known ink jet printer that includes a pair of rollers for feeding vinyl chloride film, a liquid ejection unit that performs recording by ejecting solvent ink onto the film, and a downstream-side supporting unit that is arranged on the film feed downstream side of the pair of rollers and that supports the film. This downstream-side supporting unit curves (bends) in such a manner that the height thereof decreases toward the film feed downstream side (JP-A-2013-154612).

The inventors have found the following problems.

In a recording apparatus such as a conventional ink jet printer, in the case where a medium supporting unit is curved, it is easy for the medium to come into close contact with the medium supporting unit. Consequently, there is a risk of the medium sticking to the medium supporting unit by static electricity. Further, in the case where the medium supporting unit is bent, wrinkles may form in the medium being fed to the medium supporting unit due to the accumulation and swelling of ink, and there is a risk of creases being formed in the medium along the feed direction of the medium by these wrinkles being drawn and growing at the angular portion of bent portions.

### SUMMARY

An advantage of some aspects of the invention is that a recording apparatus is provided which can suppress sticking of a medium to a medium supporting unit and suppress the formation of creases in the medium on the medium supporting unit.

A recording apparatus according to an aspect of the invention includes a feeding unit that feeds a medium, a recording section that performs recording by applying ink to the medium, and a medium supporting unit that is arranged on a medium feed downstream side of the feeding unit and that supports the medium, in which the medium supporting unit includes a bent portion that is bent so that a side that comes into contact with the medium is convex and that extends in a direction that crosses the feed direction of the medium, and a bend angle of the bent portion is equal to or more than 3° and equal to or less than 16°

According to this configuration, because the medium supporting unit includes the bent portion, it becomes difficult for the medium to be in close contact with the medium supporting unit. Consequently, sticking of the medium to the medium supporting unit by static electricity is suppressed. Further, because the bend angle of the bent portion is small, that is, equal to or more than 3° and equal to or less than 16°, drawing of wrinkles that have formed in the medium at the angular portion of the bent portion is suppressed. Consequently, it is difficult for creases to form in the medium along the feed direction of the medium. That is, the recording apparatus is capable of suppressing sticking of the medium to the medium supporting unit and suppressing the formation of creases in the medium on the medium supporting unit.

In this case, it is preferable that the medium supporting unit include a plurality of bent portions.

According to this configuration, it becomes difficult for the medium to be in close contact with the medium supporting unit. Consequently, the sticking of the medium to the medium supporting unit by static electricity is suppressed more effectively.

In this case, it is preferable that the plurality of bent portions be arranged side by side in the feed direction of the medium and the space between adjacent ones of the bent portions become increasingly wide towards the medium feed downstream side.

In this case, it is preferable that a heating unit that heats the medium through the medium supporting unit be further provided.

According to this configuration, when the medium passes over the medium supporting unit, drying of the medium is promoted.

In this case, it is preferable that the recording section apply, as the ink, sublimation ink to the medium.

In this case, it is preferable that a take-up section that is arranged on the medium feed downstream side of the medium supporting unit and that takes up the medium be further provided.

If creases form in the medium along the feed direction of the medium, it becomes easy for winding deviation to occur in a roll into which the medium has been wound up by the take-up section.

In contrast, according to this configuration, as described above, because it is difficult for creases to form in the medium, it is possible to suppress the occurrence of winding deviation in a roll into which the medium has been wound up by the take-up section.

### BRIEF DESCRIPTION OF THE DRAWINGS

The invention will be described with reference to the accompanying drawings, wherein like numbers reference like elements.

FIG. 1 is a structural diagram of the recording apparatus according to an embodiment of the invention.

FIG. 2 is a block diagram depicting control of the recording apparatus illustrated in FIG. 1.

FIG. 3A is a diagram illustrating a perspective view of a medium supporting unit included in the recording apparatus illustrated in FIG. 1.

FIG. 3B is a diagram illustrating a cross-sectional view of a medium supporting unit included in the recording apparatus illustrated in FIG. 1.

FIG. 4A is a diagram illustrating a perspective view of the medium supporting unit included in the recording apparatus of Comparative Example 1.

FIG. 4B is a diagram illustrating a cross-sectional view of the medium supporting unit included in the recording apparatus of Comparative Example 1.

FIG. 5A is a diagram illustrating a perspective view of the medium supporting unit included in the recording apparatus of Comparative Example 2.

FIG. 5B is a diagram illustrating a cross-sectional view of the medium supporting unit included in the recording apparatus of Comparative Example 2.

FIG. 6A is a photograph depicting a state in which creases are not formed in transfer paper on the medium supporting unit included in the recording apparatus illustrated in FIG. 1.

FIG. 6B is a photograph depicting a state in which creases have been formed in the transfer paper on the medium supporting unit included in the recording apparatus of Comparative Example 2.

### DESCRIPTION OF EXEMPLARY EMBODIMENTS

Below, a recording apparatus 1 according to an embodiment of the invention will be described with reference to the attached drawings. The recording apparatus 1 forms an image on transfer paper 100 by applying sublimation ink thereon by using an ink jet method. The transfer paper 100 on which the image has been formed is then supplied to a heat transfer printing device and is heated while being stacked on a dye target object such as a cloth so that the image formed on the transfer paper 100 is transferred to the dye target object.

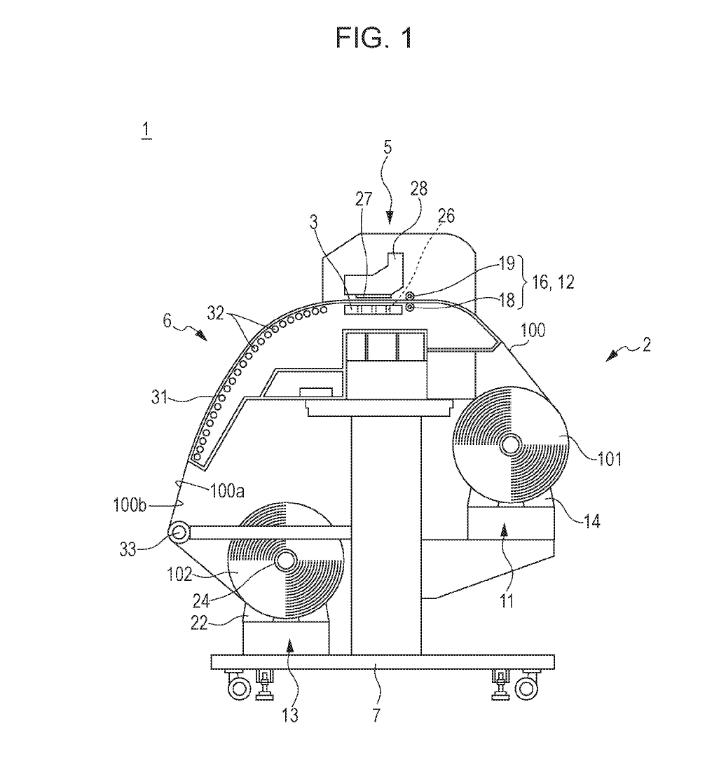

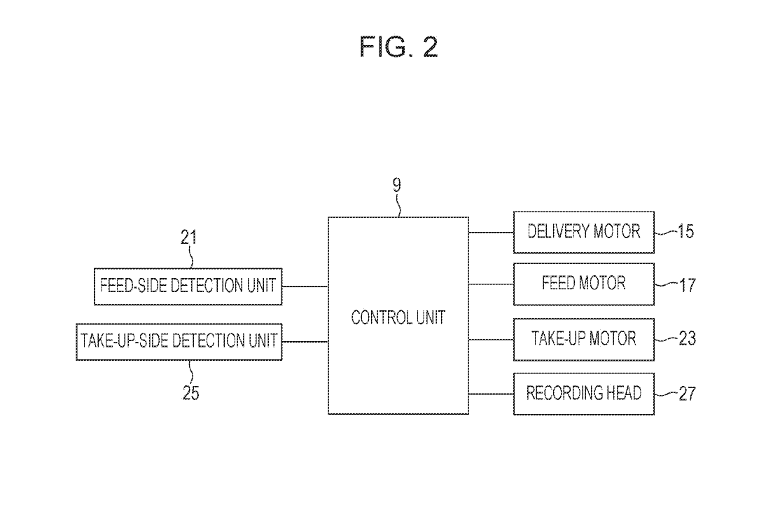

The basic configuration of the recording apparatus 1 will be described with reference to FIG. 1. The recording apparatus 1 includes a medium feeding system 2, a platen 3, a recording section 5, a drying section 6, and a supporting frame 7 that supports the aforementioned. Further, although not illustrated in FIG. 1, the recording apparatus 1 includes a control unit 9 (refer to FIG. 2).

The medium feeding system 2 feeds out the transfer paper 100, which is a continuous paper sheet, using a roll-to-roll method. The medium feeding system 2 includes a delivery section 11, a feeding unit 12, and a take-up section 13.

A delivery-side roll 101, which is the transfer paper 100 wound up into a roll, is set in the delivery section 11. The delivery section 11 includes a delivery-side supporting unit 14 and a delivery motor 15 (refer to FIG. 2). The delivery-side supporting unit 14 rotatably supports the delivery-side roll 101. The delivery motor 15 is a drive source that rotates the delivery-side roll 101. When the delivery motor 15 operates, the delivery-side roll 101 rotates in a delivery direction and the transfer paper 100 is reeled out from the delivery-side roll 101.

The feeding unit 12 feeds the transfer paper 100 reeled out from the delivery-side roll 101 toward the take-up section 13. The feeding unit 12 includes a roller pair 16 and a feed motor 17 (refer to FIG. 2). Moreover, the number of roller pairs 16 is not particularly limited, and a plurality of roller pairs 16 may be laid out along the feed path of the transfer paper 100. The roller pair 16 includes a driving roller 18 and a driven roller 19. The driving roller 18 rotates by power being transmitted from the feed motor 17. The driven roller 19 is rotated along with the rotation of the driving roller 18. The transfer paper 100 is pinched between the driving roller 18 and the driven roller 19. The feed motor 17 is a drive source that rotates the driving roller 18. When the feed motor 17 operates, the driving roller 18 rotates and the driven roller 19, which is pressed against the driving roller 18, is rotated along with the rotation of the driving roller 18. Consequently, the transfer paper 100 that is pinched between the driving roller 18 and the driven roller 19 is fed toward the take-up section 13.

Further, the driving roller 18 is provided with a feed-side detection unit 21 (refer to FIG. 2) that includes a rotary encoder. On the basis of a pulse output from the feed-side detection unit 21, the rotation angle α₁ of the driving roller 18 is detected.

The take-up section 13 winds up into a roll the transfer paper 100 that has been fed thereto. According to this embodiment, the take-up section 13 winds up the transfer paper 100 in such a manner that a recording surface 100a on which sublimation ink has been applied by the recording section 5 is on the outside and a non-recording surface 100b on which sublimation ink has not been applied is on the inside. Further, the transfer paper 100 may be wound in such a manner that the recording surface 100a on which sublimation ink has been applied by the recording section 5 is on the inside and the non-recording surface 100b on which sublimation ink has not been applied is on the outside. The take-up section 13 includes a take-up-side supporting unit 22 and a take-up motor 23 (refer to FIG. 2). The take-up-side supporting unit 22 rotatably supports a paper tube 24 that can perform winding. The leading end of the transfer paper 100 is attached to the paper tube 24. The paper tube 24 rotates by power being transmitted from the take-up motor 23 via a gear train. The take-up motor 23 is a drive source that rotates the paper tube 24. When the take-up motor 23 rotates in one direction, the paper tube 24 rotates in the take-up direction and the transfer paper 100 is wound around the paper tube 24. The roll formed by winding the transfer paper 100 around the paper tube 24 is called a take-up-side roll 102. When the take-up motor 23 rotates in the other direction, the paper tube 24 rotates in a rotation direction opposite to the take-up direction, and the transfer paper 100 wound around the paper tube 24 is unwound.

Further, the take-up motor 23 is provided with a take-up-side detection unit 25 including a rotary encoder (refer to FIG. 2). On the basis of a pulse output from the take-up-side detection unit 25, the rotation angle α₀ of the take-up motor 23 is detected.

The platen 3 is provided on the transfer paper 100 feed downstream side of the roller pair 16. The platen 3 supports the transfer paper 100 that passes over the top surface of the platen 3. A plurality of suction holes 26 are provided in the platen 3. The suction holes 26 continue to a suction fan (not illustrated). When the suction fan operates, a negative pressure acts on the suction holes 26, and the transfer paper 100 is sucked onto the top surface of the platen 3. Consequently, detachment of the transfer paper 100 from the top surface of the platen 3 is suppressed, and the transfer paper 100 is prevented from interfering with a recording head 27 of the recording section 5 (described below).

The recording section 5 is provided opposite the top surface of the platen 3. The recording section 5 includes a carriage 28 and the recording head 27 mounted on the carriage 28. The recording head 27 ejects sublimation ink onto the transfer paper 100 that is sucked onto the top surface of the platen 3. The carriage 28 having the recording head 27 mounted thereon is formed so as to be capable of reciprocating in a direction crossing the feed direction of the transfer paper 100.

The drying section 6 is provided on the transfer paper 100 feed downstream side of the recording section 5. The drying section 6 includes a medium supporting unit 31 and a heater wire 32 provided on the rear surface of the medium supporting unit 31. Since the heater wire 32 generates heat, when the transfer paper 100 that has had sublimation ink applied thereon passes over the front surface of the medium supporting unit 31, drying of the transfer paper 100 is promoted. The medium supporting unit 31 will be described below.

The supporting frame 7 includes a bar member 33. The bar member 33 forms the feed path of the transfer paper 100 between the drying section 6 and the take-up section 13.

The recording apparatus 1 formed in the above manner, repeatedly alternately performs an operation of ejecting sublimation ink from the recording head 27 while moving the carriage 28 during stoppage of intermittent feeding of the transfer paper 100 by the medium feeding system 2 and an operation of intermittently feeding the transfer paper 100 by the medium feeding system 2. Consequently, an image to be transferred to a transfer target object is formed on the transfer paper 100.

The control system of the recording apparatus 1 will be described with reference to FIG. 2. The control unit 9 includes a central processing unit (CPU), a read only memory (ROM), a random access memory (RAM), and the like, which are not illustrated. The CPU of the control unit 9 loads a program from the ROM and runs the program using the RAM, and controls each unit of the recording apparatus 1. Further, a host device (for example, a personal computer), which is not illustrated, is communicatively connected to the control unit 9. The control unit 9 is provided with image data expressing the print image from the host device or the like. The control unit 9 controls the ejection operation of the recording head 27 on the basis of the image data.

The control unit 9 controls the take-up motor 23 on the basis of a set torque T. Consequently, the transfer paper 100 is taken up by the take-up section 13 while the transfer paper 100 is under constant tension. The control unit 9 calculates the set torque T by performing initialization control at the start of operation of the recording apparatus 1.

Here, the method of calculating the set torque T will be described. The control unit 9, when starting initialization control, first causes the feed motor 17 to rotate while the take-up motor 23 is stopped. Consequently, the transfer paper 100 becomes slack between the roller pair 16 and the take-up section 13. The control unit 9 causes the take-up motor 23 to rotate while the transfer paper 100 is in a slack state. Consequently, the control unit 9 obtains an offset torque T₀ of the take-up motor 23. The offset torque T₀ is obtained on the basis of the value of an electric current that is necessary for rotating the take-up motor 23 at a static load time.

Subsequently, the control unit 9 causes the feed motor 17 and the take-up motor 23 to rotate while the transfer paper 100 is under tension between the roller pair 16 and the take-up section 13. The control unit 9 calculates from the following equation a set time feed rate L which is the feed rate of the transfer paper 100 that has been fed at this time on the basis of the relationship between the rotation angle α₁ of the driving roller 18 detected by the feed-side detection unit 21 and a roller radius r of the driving roller 18, which is already known.

L=r·α₁

Then, the control unit 9 calculates from the following equation a roll radius R of the take-up-side roll 102 on the basis of the set time feed rate L, the rotation angle α₂ of the take-up motor 23 detected by the take-up-side detection unit 25, and a speed reduction ratio N of a gear train between the take-up motor 23 and the paper tube 24, which is already known.

R=(L/α₂)·N

Further, the speed reduction ratio N is a value given by N=α₂/α₀ when the rotational angle of the paper tube 24 is α₀.

Subsequently, the control unit 9 sets a set tension F. The control unit 9, for example, stores a table of the relationship between the type of the transfer paper 100 and the value of the tension, and by referring to that table, sets the set tension F.

The control unit 9 calculates from the following equation the set torque T of the take-up motor 23 on the basis of the offset torque T₀, the roll radius R, and the set tension F obtained in this way.

T=(F·R−T₀)/N

The control unit 9, in this way, controls the take-up motor 23 on the basis of the set torque T according to the roll radius R of the take-up-side roll 102. Consequently, for example, when recording is performed by the recording section 5, even in the case where the control unit 9 causes the take-up motor 23 and the feed motor 17 to operate at the same time, excessive winding up of the transfer paper 100 by the take-up section 13 as well as insufficient winding up of the transfer paper 100 by the take-up section 13 can be suppressed.

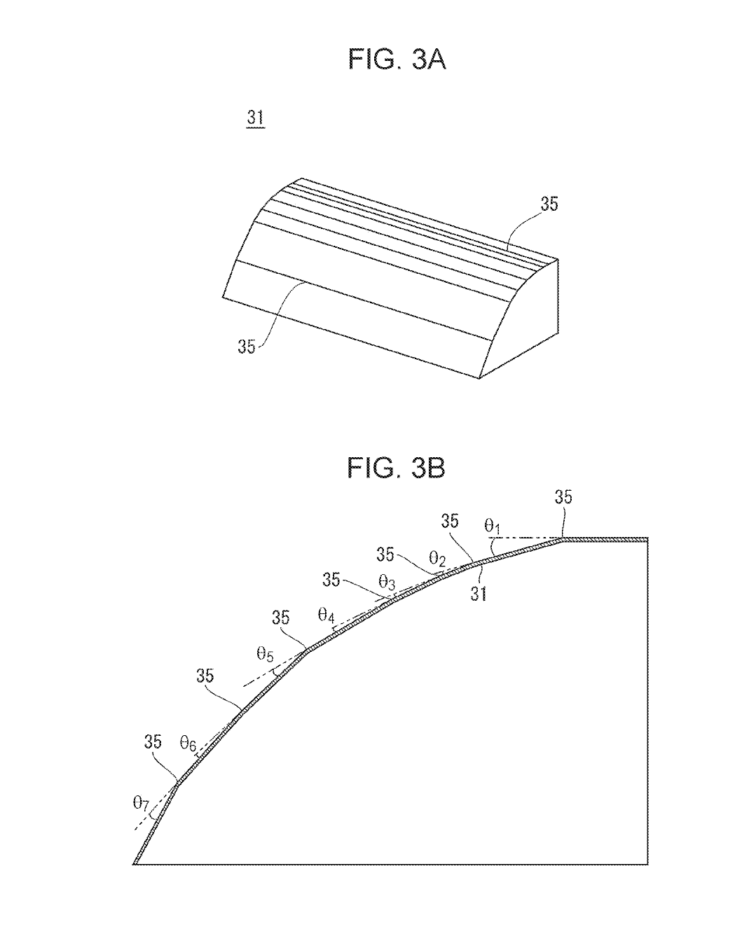

The medium supporting unit 31 will be explained with reference to FIGS. 3A and 3B. The medium supporting unit 31 is made by bending an aluminum plate and includes seven bent portions 35. Further, the number of bent portions 35 is not particularly limited. The bent portions 35 are bent in such a manner that the side that is in contact with the transfer paper 100 is convex. The surface that is in contact with the transfer paper 100 is a bent surface. Further, the bent portions 35 extend in a direction that crosses the feed direction of the transfer paper 100. That is, the medium supporting unit 31 is formed of the bent portions 35 that are bent along a direction that crosses the feed direction of the transfer paper 100. The seven bent portions 35 are arranged side by side in the feed direction of the transfer paper 100 and the space between adjacent ones of the bent portions 35 becomes increasingly wide towards the feed downstream side.

The bend angles of the bent portions 35 are in order starting from the bent portion 35 on the upstream side, θ₁=15.63°, θ₂=6.74°, θ₃=3.81°, θ₄=4.82°, θ₅=12.97°, θ_{6=4.58°}, and θ₇=13.45° (below, in the case where it is not necessary to distinguish between the bend angles θ₁ to θ₇, these are generally referred to as “bend angle θ”). As described above, the bend angle θ of the bent portions 35 is equal to or more than 3° and equal to or less than 16°.

Here, depending on the shape of the medium supporting unit 31, the transfer paper 100 may come into close contact with the medium supporting unit 31 and there is a risk that the transfer paper 100 might stick to the medium supporting unit 31 by static electricity. In particular, as described above, at the initialization control time of the recording apparatus 1, because the transfer paper 100 is fed by the feeding unit 12 while the taking up of the transfer paper 100 by the take-up section 13 is stopped in order to make the transfer paper 100 be in a slack state between the roller pair 16 and the take-up section 13, the transfer paper 100 easily sticks to the medium supporting unit 31 because the transfer paper 100 is not pulled by the take-up section 13.

In contrast, according to the recording apparatus 1 of this embodiment, because the medium supporting unit 31 includes the bent portions 35, it becomes difficult for the transfer paper 100 to be in close contact with the medium supporting unit 31. Consequently, while the taking up of the transfer paper 100 by the take-up section 13 is stopped, even when the transfer paper 100 is fed by the feeding unit 12, it is possible to suppress the sticking of the transfer paper 100 to the medium supporting unit 31 by static electricity.

However, if the bend angle θ of the bent portions 35 is large, wrinkles may form due to the accumulation and swelling of sublimation ink in the transfer paper 100 that is being fed to the medium supporting unit 31, and there is a risk of creases being formed in the transfer paper 100 along the feed direction of the transfer paper 100 by these wrinkles being drawn and growing at the angular portions of the bent portions 35. In particular, at the time of recording after the end of the initialization control of the recording apparatus 1, as described above, the take-up section 13 operates at the same time as the feeding unit 12, and because the transfer paper 100 is fed while under a set tension F, wrinkles formed in the transfer paper 100 are strongly drawn at the angular portions of the bent portions 35 and creases easily form in the transfer paper 100.

If creases form in the transfer paper 100, it becomes easy for a winding deviation to occur in which the end surface of the transfer paper 100 does not line up with the take-up-side roll 102. The winding deviation of the take-up-side roll 102 causes, for example, the transfer paper 100 to meander in a heat transfer printing device. Moreover, if creases form in the transfer paper 100 and if the recording surface 100a, in which creases have been formed, and the non-recording surface 100b of the transfer paper 100 that has been wound up on the outer side of the take-up-side roll 102 come into contact, there is a risk of the sublimation ink applied to the recording surface 100a in which creases have been formed being transferred to the non-recording surface 100b of the transfer paper 100 wound up on the outer side of the take-up-side roll 102. If such rear-side transfer occurs in the take-up-side roll 102, the amount of sublimation ink applied to the recording surface 100a will decrease only in the part subjected to rear-side transfer, and because the amount of color material transferred to the transfer target object varies depending on the location of the recording surface 100a, a color irregularity occurs in the image transferred to the transfer target object by the heat transfer printing device. Furthermore, there is also a case where creases that occur in the medium supporting unit 31 progress to the feed upstream side of the transfer paper 100, in such a case, there is a risk that the position at which the creases are formed projects out in the thickness direction of the transfer paper 100 and the transfer paper 100 may interfere with the recording head 27.

In contrast, according to the recording apparatus 1 of this embodiment, because the bend angle 0 of the bent portions 35 is small, that is, equal to or more than 3° and equal to or less than 16°, drawing of wrinkles that have formed in the transfer paper 100 at the angular portions of the bent portions 35 is suppressed. Consequently, it is difficult for creases to form in the transfer paper 100 along the feed direction of the transfer paper 100. As a result, the occurrence of winding deviation of the take-up-side roll 102, the occurrence of rear-transfer on the take-up-side roll 102, and interference between the creases and the recording head 27 can be suppressed.

Below, an example and comparative examples are given and the invention is explained more concretely.

The recording apparatus 1 of this embodiment is used as Example 1.

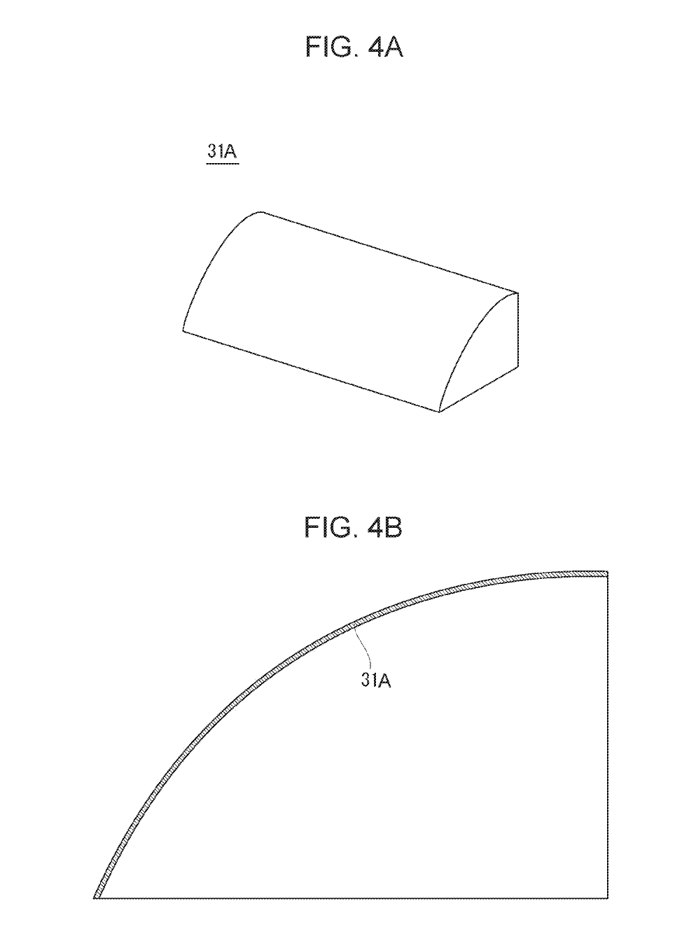

As Comparative Example 1, an apparatus substantially the same as the recording apparatus 1 of this embodiment is used except that a medium supporting unit 31A which is illustrated in FIGS. 4A and 4B is included instead of the above described medium supporting unit 31. The medium supporting unit 31A does not include the bent portions 35 and the surface that is in contact with the transfer paper 100 is a curved surface.

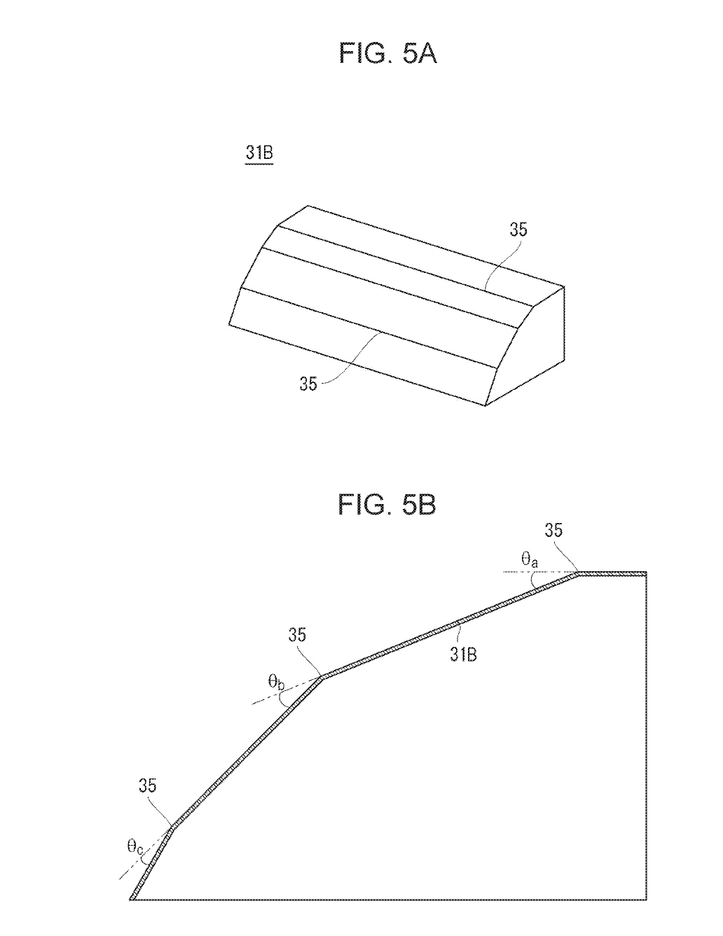

As Comparative Example 2, an apparatus substantially the same as the recording apparatus 1 of this embodiment is used except that a medium supporting unit 31B which is illustrated in FIGS. 5A and 5B is included instead of the above described medium supporting unit 31. The position of the upstream end portion of the medium supporting unit 31B and the position of the downstream end portion of the medium supporting unit 31B are substantially the same as those of the medium supporting unit 31, however, the number of bent portions 35 is three, which is smaller. Accordingly, the bend angles of the bent portions 35 are in order from the bent portion 35 on the feed upstream side, θₐ=22.36°, θ_{b}=23.33°, and θ_{c}=16.31°, and are larger than the bend angles θ₁ to θ₇. In other words, all of the bend angles θₐ to θ_{c} exceed 16°.

Further, “TexPrint (registered trademark) XPHR 44 inch width” paper (paper weight: 105 g/m²) of the Beaver Paper and Graphic Media, Inc. was used as the transfer paper 100.

In the example and comparative examples, when feeding the transfer paper 100 during initialization control, it was evaluated whether or not the transfer paper 100 stuck to the medium supporting unit 31.

In Example 1, sticking of the transfer paper 100 was not observed.

In Comparative Example 1, sticking of the transfer paper 100 was observed.

In Comparative Example 2, sticking of the transfer paper 100 was not observed.

Regarding the example and comparative examples, by performing the operation of feeding the transfer paper 100 at the time of recording after the end of initialization control, it was evaluated whether or not creases formed in the transfer paper 100 on the medium supporting unit 31.

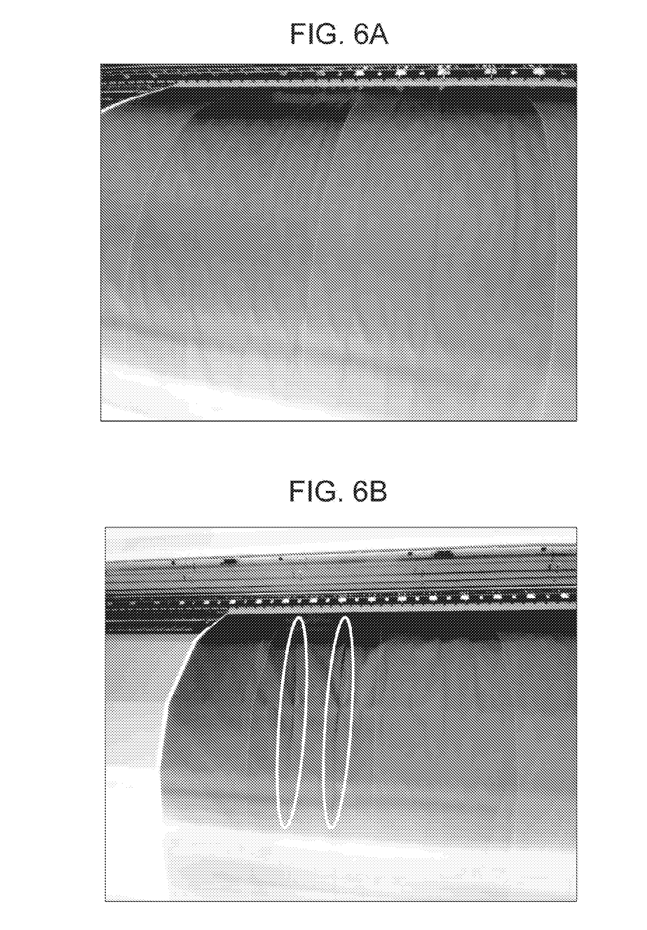

In Example 1, the formation of creases in the transfer paper 100 was not observed (refer to FIG. 6A).

In Comparative Example 1, the formation of creases in the transfer paper 100 was not observed.

In Comparative Example 2, the formation of creases in the transfer paper 100 was observed (in FIG. 6B, creases are observed in the portions surrounded by ellipses).

As stated above, according to the recording apparatus 1 of this embodiment, sticking of the transfer paper 100 to the medium supporting unit 31 is suppressed and it is possible to suppress the occurrence of creases in the transfer paper 100 on the medium supporting unit 31.

Further, because the medium supporting unit 31 according to the recording apparatus 1 of this embodiment has a plurality of the bent portions 35, it is difficult for the transfer paper 100 to be in close contact with the medium supporting unit 31. Consequently, the sticking of the transfer paper 100 to the medium supporting unit 31 by static electricity is suppressed more effectively.

Further, the heater wire 32 is one example of the “heating unit”. The transfer paper 100 is one example of the “medium”.

The invention is not limited to the above described embodiment, and it goes without saying that it is possible to adopt various configurations as long as they do not deviate from the scope of the invention. For example, the embodiment can be changed to the following form.

The ink ejected by the recording section 5 is not limited to sublimation ink and may be, for example, water-based ink, oil-based ink, solvent ink, or ultraviolet curable type ink. Further, the material of the medium is not particularly limited, and items made of various materials such as paper-type or film-type items may be used. Further, an inexpensive thin item (for example, paper weight of 75 g/m² or less) is often used for the transfer paper 100. In that case, the transfer paper 100 easily sticks to the medium supporting unit 31 by static electricity or the like. Further, wrinkles may easily form due to the accumulation and swelling of ink in the transfer paper 100. Consequently, this invention is particularly useful for the transfer paper 100, which is thin.

The entire disclosure of Japanese Patent Application No.2015-23891, filed Feb. 10, 2015 is expressly incorporated by reference herein.

What is claimed is:

1. A recording apparatus comprising:
a feeding unit that feeds a medium;
a recording section that performs recording by applying ink to the medium; and
a medium supporting unit that is arranged on a medium feed downstream side of the feeding unit and that supports the medium;
wherein the medium supporting unit includes a bent portion that is bent so that a side that comes into contact with the medium is convex and that extends in a direction that crosses the feed direction of the medium, and
a bend angle of the bent portion is equal to or more than 3° and equal to or less than 16°.

2. The recording apparatus according to claim 1, wherein the medium supporting unit includes the bent portion in a plurality.

3. The recording apparatus according to claim 2, wherein the plurality of bent portions are arranged side by side in the feed direction of the medium, and the distance between adjacent ones of the plurality of bent portions increases toward the medium feed downstream side.

4. The recording apparatus according claim 1, further comprising:
a heating unit that heats the medium through the medium supporting unit.

5. The recording apparatus according to claim 1,
wherein the recording section applies, as the ink, sublimation ink to the medium.

6. The recording apparatus according to claim 1, further comprising:
a take-up section that is arranged on the medium feed downstream side of the medium supporting unit and that takes up the medium.
